(19) United States
(12) Patent Application Publication
(10) Pub. No.: US 2026/0159126 A1
(43) Pub. Date: Jun. 11, 2026

(54) VEHICLE CONTROL DEVICE AND METHOD

(71) Applicants: Hyundai Motor Company, Seoul (KR); Kia Corporation, Seoul (KR)

(72) Inventors: Min Sung Kim, Hwaseong-si (KR); Sung Kwan Kim, Hwaseong-si (KR); Sung Hwan Yun, Hwaseong-si (KR); Ji Hong Kim, Hwaseong-si (KR); Sung Woo Jang, Hwaseong-si (KR); Dong Gyu Kim, Hwaseong-si (KR); Seung II Han, Hwaseong-si (KR)

(21) Appl. No.: 19/230,304

(22) Filed: Jun. 6, 2025

(30) Foreign Application Priority Data
Dec. 10, 2024 (KR) 10-2024-0182468

(51) Int. Cl. B60W 60/00; G01C 21/34

(52) U.S. Cl. CPC B60W 60/0011; G01C 21/3453; B60W 2520/105; B60W 2540/18

(57) ABSTRACT

An apparatus of a vehicle may include one or more processors and a memory. The memory may store at least one instruction that is configured, when executed by the one or more processors communicating with the memory, to cause the apparatus to: generate, via a navigation system of the vehicle and based on surrounding object information obtained from a sensor of the vehicle, a plurality of candidate routes to merge with a target route from a location of the vehicle; determine an amount of deviation, from the target route, of a route on which the vehicle is traveling; determine an optimal route, among the plurality of candidate routes, that minimizes the amount of deviation from the target route; generate a vehicle control signal to follow the optimal route; and control, based on the vehicle control signal, a driving operation of the vehicle.

### CROSS-REFERENCE TO RELATED APPLICATION

This application claims priority to Korean Patent Application No. 10-2024-0182468, filed on Dec. 10, 2024, the disclosure of which is incorporated herein by reference in its entirety for all purposes.

### TECHNICAL FIELD

Embodiments relate to a vehicle control device and method.

### BACKGROUND

Route generation algorithms may plan optimal routes for a vehicle based on a set of fixed criteria without considering current driving conditions or performance of the vehicle. For example, routes may often be generated using only map data and static boundary conditions, and errors or inaccuracies that may be found while following the route may not be reflected at a route generation stage. This may cause small errors that occur as the vehicle follows the route to accumulate over time, or cause a decline in performance of route guidance due to complex situations and or unforeseen events such as sharp curves or obstacle avoidance.

In particular, vehicle behavior may become unstable due to routes being generated without reflecting any physical limitations of the vehicle (e.g., a steering angle and a speed change limit), which may impair the riding comfort of occupants and increase the risk of accidents.

### SUMMARY

The present disclosure is directed to providing a vehicle control device and method capable of minimizing driving instability due to accumulated errors by considering following performance in a route generation stage of an autonomous vehicle and reflecting a following error in route generation in real time.

According to one or more example embodiments of the present disclosure, an apparatus of a vehicle may include: one or more processors; and a memory. The memory may store at least one instruction that is configured, when executed by the one or more processors communicating with the memory, to cause the apparatus to: generate, via a navigation system of the vehicle and based on surrounding object information obtained from a sensor of the vehicle, a plurality of candidate routes to merge with a target route from a location of the vehicle; determine an amount of deviation, from the target route, of a route on which the vehicle is traveling; determine an optimal route, among the plurality of candidate routes, that minimizes the amount of deviation from the target route; generate a vehicle control signal to follow the optimal route; and control, based on the vehicle control signal, a driving operation of the vehicle.

The at least one instruction may be configured, when executed by the one or more processors communicating with the memory, to cause the apparatus to determine the optimal route by: determining the optimal route based on a number of times, that the amount of deviation of the route exceeds a threshold deviation amount, being greater than a threshold quantity value.

The at least one instruction may be configured, when executed by the one or more processors communicating with the memory, to cause the apparatus to generate the plurality of candidate routes by: generating the plurality of candidate routes to connect the location of the vehicle to the target route along a center route of a lane on which the vehicle is traveling.

The at least one instruction may be configured, when executed by the one or more processors communicating with the memory, to cause the apparatus to determine the amount of deviation of the route by: determining the amount of deviation of the route based on steering angle and acceleration values of the vehicle for maintaining the center route of the lane.

The at least one instruction may be configured, when executed by the one or more processors communicating with the memory, to cause the apparatus to determine the optimal route by: determining the optimal route based on a cost function. The cost function may include a longitudinal and lateral jerk cost, a target speed cost, and a target route offset cost.

The at least one instruction may be configured, when executed by the one or more processors communicating with the memory, to cause the apparatus to determine the optimal route by adjusting a weight of the target route offset cost.

The at least one instruction may be configured, when executed by the one or more processors communicating with the memory, to cause the apparatus to determine the optimal route by: applying the target route offset cost, with the adjusted weight, in the cost function and determining the optimal route so that the cost function is minimized.

The at least one instruction may be configured, when executed by the one or more processors communicating with the memory, to cause the apparatus to determine the optimal route by: determining, based on a number of times, that the amount of deviation of the route exceeds a threshold deviation amount, being less than a threshold quantity value, one of the plurality of candidate routes as the optimal route.

The at least one instruction may be configured, when executed by the one or more processors communicating with the memory, to cause the apparatus to determine the optimal route by: determining, based on vehicle driving information about the vehicle and the surrounding object information, a collision risk level; and determining, based on the collision risk level being greater than or equal to a threshold value, one of the plurality of candidate routes as the optimal route.

The at least one instruction may be configured, when executed by the one or more processors communicating with the memory, to further cause the apparatus to display, via a display device of the vehicle, the plurality of candidate routes and the optimal route.

According to one or more example embodiments of the present disclosure, a method performed by an apparatus of a vehicle may include: generating, via a navigation system of the vehicle and based on surrounding object information obtained from a sensor of the vehicle, a plurality of candidate routes to merge with a target route from a location of the vehicle; determining an amount of deviation, from the target route, of a route on which the vehicle is traveling; determining an optimal route, among the plurality of candidate routes, that minimizes the amount of deviation from the target route; generating a vehicle control signal to follow the optimal route; and controlling, based on the vehicle control signal, a driving operation of the vehicle.

Determining the optimal route may include: determining the optimal route based on a number of times, that the amount of deviation of the route exceeds a threshold deviation amount, being greater than a threshold quantity value.

Generating the plurality of candidate routes may include: generating the plurality of candidate routes to connect the location of the vehicle to the target route along a center route of a lane on which the vehicle is traveling.

Determining the amount of deviation of the route may include: determining the amount of deviation of the route based on steering angle and acceleration values of the vehicle for maintaining the center route of the lane.

Determining the optimal route may include: determining the optimal route based on a cost function. The cost function may include a longitudinal and lateral jerk cost, a target speed cost, and a target route offset cost.

Determining the optimal route may include adjusting a weight of the target route offset cost.

Determining the optimal route may include: applying the target route offset cost, with the adjusted weight, in the cost function and determining the optimal route so that the cost function is minimized.

Determining the optimal route may include: determining, based on a number of times, that the amount of deviation of the route exceeds a threshold deviation amount, being less than a threshold quantity value, one of the plurality of candidate routes as the optimal route.

The method may further include, prior to the determining of the optimal route, determining, based on vehicle driving information about the vehicle and the surrounding object information, a collision risk level.

Determining of the optimal route may include: determining, based on the collision risk level being greater than or equal to a threshold value, one of the plurality of candidate routes as the optimal route.

### BRIEF DESCRIPTION OF THE DRAWINGS

The above and other objects, features and advantages of the present disclosure will become more apparent to those of ordinary skill in the art by describing one or more example embodiments thereof in detail with reference to the accompanying drawings, in which:

FIG. 1 is a view showing a vehicle transmitting and receiving data by communicating with other devices;

FIG. 2 is a diagram showing modules constituting a vehicle;

FIG. 3 is a diagram for describing the operation of a processor;

FIGS. 4A and 4B are conceptual diagrams for describing an example route tracking process of a vehicle; and

FIG. 5 is a flowchart of a method of controlling a vehicle.

### DETAILED DESCRIPTION

Hereinafter, one or more example embodiments of the present disclosure will be described in detail with reference to the accompanying drawings.

However, the technical idea of the present disclosure is not limited to the example embodiments to be described but may be implemented in various different forms, and within the scope of the technical idea of the present disclosure, one or more among components in the example embodiments may be used by being selectively combined and substituted.

Unless specifically defined and described, terms used in the example embodiments of the present disclosure (including technical and scientific terms) may be interpreted as meanings which are generally understood by those skilled in the art to which the present disclosure pertains, and commonly used terms such as terms defined in dictionaries may be interpreted in consideration of the contextual meaning of the related art.

The terms used in the example embodiments of the present disclosure are for the purpose of describing the example embodiments only and are not intended to limit the disclosure.

In the present specification, the singular forms may include the plural forms unless the context clearly dictates otherwise, and when described as “at least one (or one or more) among A, B, and (or) C,” it may include one or more of all possible combinations of A, B, and C.

In addition, when describing components of example embodiments of the present disclosure, terms such as first, second, A, B, (a), (b), etc., may be used.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

The term “module” or “unit” used in the specification means a software and/or hardware component, and the “module” or “unit” performs certain operations/functions/roles. However, the “module” or “unit” is not construed as being limited to software or hardware. The “module” or “unit” may be configured to be in an addressable storage medium or to execute one or more processors. Therefore, as an example, the “module” or “unit” may include at least one of components such as software components, object-oriented software components, class components, and task components, processes, functions, attributes, procedures, sub-routines, segments of program codes, drivers, firmware, micro-codes, circuits, data, databases, data structures, tables, arrays, or variables. Functions provided in the components, “modules”, or “units” may be combined into a smaller number of components, “modules”, or “units” or further divided into additional components, “modules”, or “units”.

In the present disclosure, the “module” or “unit” may be realized as a processor and a memory. The “processor” should be widely construed to include a general-purpose processor, a central processing unit (CPU), a microprocessor, a digital signal processor (DSP), a microcontroller, a state machine, or the like. In some environments, the “processor” may refer to an application-specific integrated circuit (ASIC), a programmable logic device (PLD), or a field-programmable gate array (FPGA), and the like. For example, the “processor” may refer to a combination of processing devices such as a combination of a DSP and a microprocessor, a combination of a plurality of microprocessors, a combination of one or more microprocessors combined with a DSP core, or any other such combination. Moreover, the “memory” should be widely construed to include any electronic component capable of storing electronic information. The “memory” may refer to various types of processor-readable medium such as a random access memory (RAM), a read only memory (ROM), a non-volatile random access memory (NVRAM), a programmable read only memory (PROM), an erasable programmable read only memory (EPROM), an electrically erasable programmable read only memory (EEPROM), a flash memory, a magnetic or optical data storage device, and registers. When the processor can read information from a memory and/or record the information in the memory, the memory may be in a state of electronic communication with a processor. Memory integrated into a processor is in a state of electronic communication with the processor.

The one or more features described herein may be provided as a computer program stored in a computer-readable recording medium in order to be executed on a computer. The medium may either continuously store a computer-executable program or temporarily store the program for execution or download. Furthermore, the medium may be a variety of recording or storage means in the form of a single hardware device or multiple combined hardware devices, and is not limited to media directly connected to some computer system but may also be distributed across a network. Examples of such media include magnetic media such as a hard disk, a floppy disk, or a magnetic tape, optical recording media such as a CD-ROM or a DVD, magneto-optical media such as a floptical disk, and a ROM, RAM, or flash memory, among others, configured to store program instructions. Additional examples of such media include media or storage media that are managed by an app store that distributes applications or by various other sites or servers that provide or distribute software.

In a hardware implementation, processing units used for performing the techniques may be implemented within one or more ASICs, DSPs, digital signal processing devices, programmable logic devices, field-programmable gate arrays, processors, controllers, microcontrollers, microprocessors, electronic devices, or computers or combinations thereof designed to perform the functions described in the present disclosure.

These terms are only for distinguishing the components from other components, and the essence, sequence, or order of the components is not limited by these terms.

In addition, when a component is described as being “linked,” “coupled,” or “connected” to another component, the component is not only directly linked, coupled, or connected to another component, but also “linked,” “coupled,” or “connected” to another component with still another component disposed between the component and the other component.

If a component is described as being formed or disposed “on (above) or under (below)” another component, the term “on (above) or under (below)” includes not only when two components are in direct contact with each other, but also when one or more other components are formed or disposed between the two components. If a component is described as being “on (above) or below (under),” the description may include the meanings of an upward direction and a downward direction based on one component.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein. One or more features associated with autonomous driving control may be activated based on configured autonomous driving control setting(s) (e.g., based on at least one of: an autonomous driving classification, a selection of an autonomous driving level for a vehicle, etc.).

Based on one or more features (e.g., determining an optimal route) described herein, an operation of the vehicle may be controlled. The vehicle control may include various operational controls associated with the vehicle (e.g., autonomous driving control, sensor control, braking control, braking time control, acceleration control, acceleration change rate control, alarm timing control, forward collision warning time control, etc.).

One or more auxiliary devices (e.g., engine brake, exhaust brake, hydraulic retarder, electric retarder, regenerative brake, etc.) may also be controlled, for example, based on one or more features (e.g., determining an optimal route) described herein. One or more communication devices (e.g., a modem, a network adapter, a radio transceiver, an antenna, etc., that is capable of communicating via one or more wired or wireless communication protocols, such as Ethernet, Wi-Fi, near-field communication (NFC), Bluetooth, Long-Term Evolution (LTE), 5G New Radio (NR), vehicle-to-everything (V2X), etc.) may also be controlled, for example, based on one or more features (e.g., determining an optimal route) described herein.

Minimum risk maneuver (MRM) operation(s) may also be controlled, for example, based on one or more features (e.g., determining an optimal route) described herein. A minimal risk maneuvering operation (e.g., a minimal risk maneuver, a minimum risk maneuver) may be a maneuvering operation of a vehicle to minimize (e.g., reduce) a risk of collision with surrounding vehicles in order to reach a lowered (e.g., minimum) risk state. A minimal risk maneuver may be an operation that may be activated during autonomous driving of the vehicle when a driver is unable to respond to a request to intervene. During the minimal risk maneuver, one or more processors of the vehicle may control a driving operation of the vehicle for a set period of time.

Biased driving operation(s) may also be controlled, for example, based on one or more features (e.g., determining an optimal route) described herein. A driving control apparatus may perform a biased driving control. To perform a biased driving, the driving control apparatus may control the vehicle to drive in a lane by maintaining a lateral distance between the position of the center of the vehicle and the center of the lane. For example, the driving control apparatus may control the vehicle to stay in the lane but not in the center of the lane.

The driving control apparatus may identify a biased target lateral distance for biased driving control. For example, a biased target lateral distance may comprise an intentionally adjusted lateral distance that a vehicle may aim to maintain from a reference point, such as the center of a lane or another vehicle, during maneuvers such as lane changes. This adjustment may be made to improve the vehicle's stability, safety, and/or performance under varying driving conditions, etc. For example, during a lane change, the driving control system may bias the lateral distance to keep a safer gap from adjacent vehicles, considering factors such as the vehicle's speed, road conditions, and/or the presence of obstacles, etc.

One or more sensors (e.g., IMU sensors, camera, LIDAR, RADAR, blind spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, inverter, converter, motor controller, power distribution unit, high-voltage wiring and connectors, auxiliary power modules, charging interface, etc.) may also be controlled, for example, based on one or more features (e.g., determining an optimal route) described herein.

An operation control for autonomous driving of the vehicle may include various driving control of the vehicle by the vehicle control device (e.g., acceleration, deceleration, steering control, gear shifting control, braking system control, traction control, stability control, cruise control, lane keeping assist control, collision avoidance system control, emergency brake assistance control, traffic sign recognition control, adaptive headlight control, etc.).

In at least some implementations, a route generation system and a route tracking system may operate using independent algorithms. After a route is generated, the vehicle may follow the generated route through a tracking algorithm, but even when a tracking error that occurs during driving is detected, it may be difficult to respond immediately due to the lack of linkage with a route generation algorithm.

For example, if an unexpected obstacle or change in road conditions occurs while following the generated route, a tracking error may occur, but the tracking error may not be fed into the route generation algorithm to reflect the tracking error in real time. This may cause a discrepancy between route generation and route tracking, and thus, problems may arise that result in the vehicle exhibiting an unstable behavior or deviating from the route.

Therefore, since the route generation system and the route tracking system independently try to minimize the error, it may be ultimately difficult to ensure consistency and stability of the entire system as a whole. For example, if a route tracking algorithm attempts to make a sharp steering angle change to reduce a tracking error, the vehicle behavior may become unstable. Conversely, even after an optimal route is suggested during the route generation stage, if the vehicle does not accurately follow the optimal route during the tracking stage, the performance of the entire system may be degraded.

Hereinafter, one or more example embodiments will be described in detail with reference to the accompanying drawings, but the same or corresponding components are denoted by the same reference numerals regardless of the drawing numbers, and redundant descriptions thereof will be omitted.

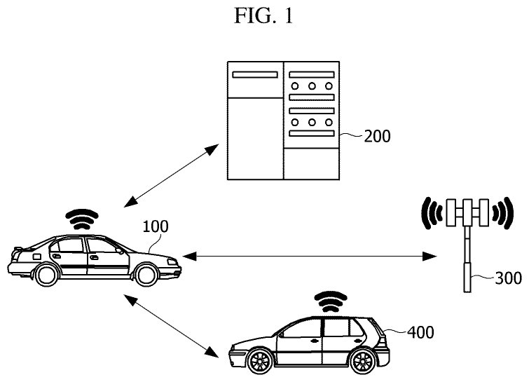

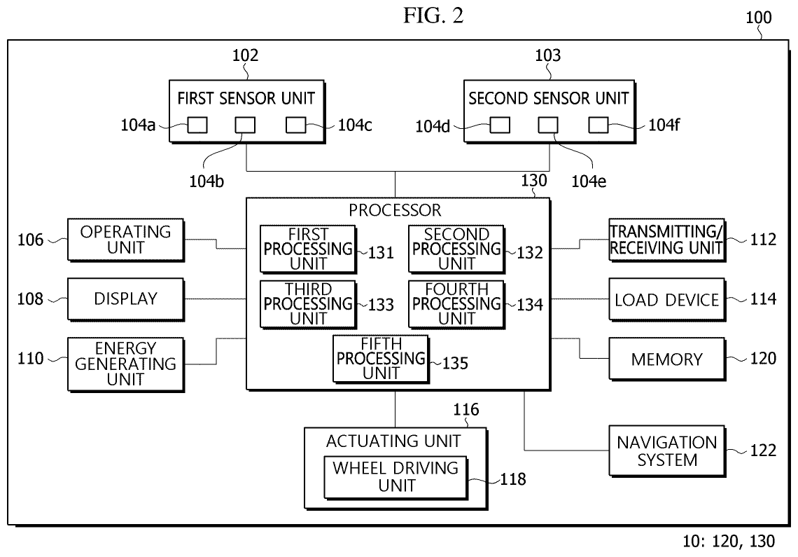

Hereinafter, a vehicle will be described with reference to FIGS. 1 and 2. FIG. 1 is a view showing a vehicle transmitting and receiving data by communicating with other devices.

Referring to FIG. 1, a vehicle 100 may be driven based on electrical energy or fossil energy. In the case of electrical energy, the vehicle 100 may be, for example, a battery-based vehicle driven only by a high-voltage battery, or may employ a gas-based fuel cell as an energy source. In addition, the fuel cell may use various types of gas capable of generating electrical energy, and the vehicle 100 may be filled with, for example, gas in a liquefied state. One example of the gas may be hydrogen. However, the gas is not limited thereto, and various gases are applicable. In the case of fossil energy, the vehicle 100 may be driven based on fuel such as gasoline, diesel, or liquefied gas, and may be equipped with an internal combustion engine that drives an actuating unit (also referred to as an actuator) 116 by combustion of the fuel. The engine may be included in an energy generating unit (also referred to as a generator, a power generator, an energy generator, etc.) 110 in terms of providing a driving rotational force of wheels to a wheel driving unit (e.g., a powertrain) 118. As another example, the vehicle 100 may drive the actuating unit 116 by selectively utilizing energy from a fossil energy-based internal combustion engine and an electric battery, and may be a hybrid type vehicle.

The vehicle 100 may refer to a movable device. The vehicle 100 is a ground vehicle that travels on the ground and may be a typical passenger car, a commercial vehicle, a purpose-built vehicle (PBV), or the like. The vehicle 100 may be a four-wheeled vehicle, such as a passenger car, a sport utility vehicle (SUV), or a small truck, or may be a vehicle with more than four wheels, such as a bus, a large truck, a container transport vehicle, a heavy equipment vehicle, or the like. The ground vehicle may be referred to as any vehicle including a vehicle that moves underground as well as a vehicle that moves over land. The vehicle 100 may be a robot in a broad sense, such as a means of movement, and the robot may be moved using wheels, tracks, or other movement modules. In the present disclosure, ground mobility devices such as ground vehicles are mainly described, but unless it contradicts the present disclosure, the example embodiments may also be applied to air mobility devices such as advanced air mobility (AAM) vehicles, aircraft, or the like, and water mobility devices such as ships, submarines, or the like.

The vehicle 100 may be controlled and driven by autonomous driving, and the autonomous driving may be implemented as semi-autonomous driving or fully autonomous driving. Fully autonomous driving may be provided as autonomous movement in which a processor 130 of the vehicle 100 takes full control without user intervention, even when a driving situation is uncertain. Semi-autonomous driving may be provided as autonomous movement that requires driver intervention depending on specific driving situations. The semi-autonomous driving may be implemented so that the processor 130 transfers control to a user by deactivating autonomous driving when the aforementioned situation occurs, allowing the user to perform manual driving. According to the levels of autonomous driving defined by the Society of Automotive Engineers (SAE), the semi-autonomous driving may correspond to autonomous driving levels 1 to 4, and the fully autonomous driving may correspond to level 5.

The vehicle 100 may communicate with other devices 200 and 300 or another vehicle 400. Other devices may include, for example, a server 200 that supports various controls, state management, and driving of the vehicle 100, an intelligent transportation system (ITS) device 300 for receiving information from an ITS, various types of user devices, or the like. The server 200 may be, for example, an external device operated by a vehicle manufacturer or provided to service autonomous driving, and may receive connected data of the vehicle 100 or transmit data necessary for autonomous driving. The server 200 may transmit various information and software modules used to control the vehicle 100 to the vehicle 100 in response to requests and data transmitted from the vehicle 100 and the user device to support autonomous driving and various services of the vehicle 100.

The ITS device 300 may be, for example, a roadside unit (RSU), and the ITS device 300 may assist the user in driving his or her own vehicle or support autonomous driving of the vehicle 100 by exchanging vehicle recognition data, driving control and state data, environmental data around the vehicle, map data, or the like, through vehicle-to-infrastructure (V2I) communication with the vehicle 100. The vehicle 100 may support manual driving or autonomous driving by exchanging the data listed above through vehicle-to-vehicle (V2V) communication with the other vehicle 400.

The vehicle 100 may communicate with other vehicles or other devices based on cellular communication, wireless access in vehicular environment (WAVE) communication, dedicated short range communication (DSRC), short-range communication, or other communication methods.

For example, the vehicle 100 may use a cellular communication network such as LTE or 5G, a Wi-Fi communication network, a WAVE communication network, or the like, for communication with the server 200, the ITS device 300, and the other vehicle 400. For another example, DSRC or the like used in the vehicle 100 may be used for communication between vehicles. The communication method between the vehicle 100, the server 200, the ITS device 300, the other vehicle 400, and the user device is not limited to the example embodiments described herein.

FIG. 2 is a diagram showing modules constituting a vehicle according to one embodiment of the present disclosure;

The vehicle 100 may include sensors 102 and 103, an operating unit (also referred to as a user interface, a control panel, a dashboard, an instrument cluster, an instrument panel, etc.) 106, a display 108, a load device (also referred to as a load or an electrical load) 114, and a transmitting/receiving unit (also referred to a communication interface, a transceiver, etc.) 112.

The sensor 102 may be provided with various types of detectors to detect various states and situations occurring in an external environment, an internal system, user operation, and a boarding space of the vehicle 100.

Specifically, the first sensor 102 may be provided with an externally oriented camera 104a, a lidar sensor 104b, a radar sensor 104c, and the like, to recognize dynamic and static objects present outside the vehicle 100. The camera 104a may recognize an external object as an image while the vehicle 100 is in use, generate image data, and transmit the image data to the processor 130. The lidar sensor 104b may generate point cloud data as recognized data of the external object and transmit the point cloud data to the processor 130 to generate 3D spatial information that identifies at least a shape of the external object. In order to ascertain the presence of an external object and its relative distance, speed, direction, or the like, the radar sensor 104c may emit radio waves of a specific frequency around the vehicle 100 and generate radar data through radio waves reflected from the external object. In the present disclosure, the sensor is illustrated as having the lidar sensor 104b, but in other examples, the lidar sensor 104b may not be mounted.

The first sensor 102 may generate object recognition information based on sensing data. The object recognition information may include information on the presence of an object, position information about the object, information on a distance between the vehicle 100 and the object, and information on a relative speed between the vehicle 100 and the object. In the embodiment, external objects may be various objects related to the operation of the vehicle 100.

A second sensor 103 may be provided with a positioning sensor 104d, a wheel sensor 104e, an attitude sensor 104f, and the like, to confirm its own location, speed, driving attitude, and the like. The attitude sensor 104f may include a gyro sensor, an angular velocity sensor, an acceleration sensor, or the like. The attitude sensor may be an inertial measurement unit (IMU) sensor and may be equipped with a 3-axis accelerometer and a 3-axis gyroscope. The attitude sensor may measure acceleration in a traveling direction (x), acceleration in a lateral direction (y), and acceleration in a height direction (z) of the vehicle 100, and a yaw, a pitch, and a roll as the angular velocity of the vehicle.

The second sensor 103 may generate vehicle driving information based on sensing data. The vehicle driving information may be information generated based on data detected by various sensors installed inside the vehicle. For example, the vehicle driving information may include vehicle attitude information, vehicle speed information, vehicle inclination information, vehicle weight information, vehicle direction information, vehicle battery information, vehicle fuel information, vehicle tire pressure information, vehicle steering information, vehicle interior temperature information, vehicle interior humidity information, pedal position information, vehicle engine temperature information, and the like.

In addition, the vehicle driving information may include route information. The route information may refer to information generated based on a destination input by a vehicle user through the operating unit 106. The route information may refer to information that indicates a traveling route from a current position of a host vehicle to a destination on a map when the destination has been set. When no destination is set, the route information may refer to information including a road on which the host vehicle is currently traveling and a future driving route including the road.

The operating unit 106 may be configured as a module that is controlled by the user for driving. For example, the operating unit 106 may be a steering wheel for manual driving, an automatic or manual shift transmission, an accelerator pedal, a brake pedal, or the like. The operating unit 106 may be further provided with an interface for enabling or disabling an autonomous driving mode and selecting detailed functions requested by the user so that the user may use an autonomous driving function. In order to receive various requests related to autonomous driving, the operating unit 106 may be configured, for example, as a hard-type interface provided at a predetermined position inside the vehicle 100, or as a soft-type interface that may be touched on the display 108. Depending on the specifications of the autonomous vehicle, at least one of the steering wheel, the transmission, and the pedal may be omitted. For another example, the operating unit 106 may be provided with a module that receives a user's control request for the load device 114 in addition to driving control.

The display 108 may function as a user interface. The display 108 may output and display an operating state, a control state, route/traffic information, remaining energy amount information, content requested by the driver, or the like, of the vehicle 100 by the processor 130. In addition, the display 108 may be configured as a touch screen capable of detecting a driver's input to receive a driver's request to instruct the processor 130.

The load device 114 may be mounted on the vehicle 100 and may be any electrical device that is unrelated to a driving power system such as the wheel driving unit 118 or the like. The load device 114 is an auxiliary device that receives electrical power from the energy generating unit 110, and may be, for example, an air conditioning system, a lighting system, a seat system, various devices installed in the vehicle 100, or the like. In the present disclosure, a cooling/heating system that cools or heats at least one of a battery, a fuel cell, an internal combustion engine, an air conditioning system, and a specific part of the vehicle 100 may be further included.

The transmitting/receiving unit 112 may support mutual communication with the server 200, the ITS device 300, surrounding vehicles 300, and the like. The transmitting/receiving unit 112 may include a module that processes, for example, cellular communication, WAVE, DSRC communication, and the like. In the present disclosure, the transmitting/receiving unit 112 may transmit data generated or stored while driving to the server 200 and receive data and software modules transmitted from the server 200. The transmitting/receiving unit 112 may support communication with an electronic device carried by an occupant inside the vehicle 100. In the present disclosure, the vehicle 100 may transmit and receive data utilized in a method according to the present disclosure to and from the outside through the transmitting/receiving unit 112.

For example, the transmitting/receiving unit 112 may receive traffic signal information from a traffic signal controller and provide the traffic signal information to the processor 130. In addition, the transmitting/receiving unit 112 may receive a control signal from the traffic signal controller and provide the control signal to the processor 130.

In addition, the vehicle 100 may include the energy generating unit 110 and the actuating unit 116.

The energy generating unit 110 may generate and supply power and electric power used in a driving power system and a non-driving power system, such as the actuating unit 116. The non-driving power system may be, for example, the sensor 102, the operating unit 106, the display 108, the load device 114, and the transmitting/receiving unit 112, but is not limited thereto, and may include various components that implement sensing, interface, communication, and convenience functions, excluding components directly involved in driving operations. When the vehicle 100 is driven based on electrical energy, the energy generating unit 110 may be configured as an electric battery charged from the outside, or configured as a combination of an electric battery and a fuel cell that charges the electric battery. In the case of the combination of the electric battery and the fuel cell, the energy generating unit 110 may include a tank that stores materials used to produce electric power for the fuel cell, such as liquefied hydrogen. When the vehicle 100 is driven based on fossil energy, the energy generating unit 110 may be configured as an internal combustion engine. In addition, when the vehicle 100 is a hybrid type, the energy generating unit 110 may be provided as a combination of the internal combustion engine and the electric battery.

The actuating unit 116 may be provided with at least one module that implements driving operations and perform at least one driving operation among longitudinal control such as acceleration and deceleration and lateral control such as steering, according to a user request from the operating unit 106. In order to perform driving operations according to a command of the processor 130 by manual operation of the user or autonomous driving, the actuating unit 116 may be provided with the wheel driving unit 118 and mechanical components and electronic modules for implementing the driving operations in the wheel driving unit 118. When the vehicle 100 is operated based on electrical energy, the actuating unit 116 may include an assembly for transmitting the requested driving operation to the wheel driving unit 118. When the vehicle 100 is operated based on fossil energy, the actuating unit 116 may be provided with a transmission and a gear module that transmit the power of the internal combustion engine.

The wheel driving unit 118 may include a plurality of wheels, a driving force generation module (e.g., engine, motor, etc.) for generating a driving force and applying the driving force to the wheels or transmitting the driving force, a braking module for slowing down the driving of the wheels, and a steering module for carrying out lateral control of the wheels. When the vehicle 100 is driven based on electrical energy, the driving force generating module may be configured as a motor assembly that generates a driving force based on electric power output from the electric battery. The braking module of the electric-based vehicle 100 may further have a regenerative braking function.

A navigation unit (also referred to as a navigation system) 122 may provide navigation information. The navigation information may include at least one of map information, set destination information, route information according to a set destination, information on various objects on the route, lane information, and current vehicle position information.

The navigation unit 122 may receive information from an external device through the transmitting/receiving unit 112 and update previously stored information. According to the embodiment, the navigation unit 122 may be classified as a sub-component of the operating unit 106.

The vehicle control device 10 according to the embodiment may include a memory 120 and the processor 130.

The memory 120 may store applications and various types of data for controlling the vehicle 100, and load applications or read and record data by a request of the processor 130.

The processor 130 may perform overall control of the vehicle 100. The processor 130 may be configured to execute applications and instructions stored in the memory 120.

The processor 130 may include a first processing unit 131, a second processing unit 132, a third processing unit 133, a fourth processing unit 134, and a fifth processing unit 135.

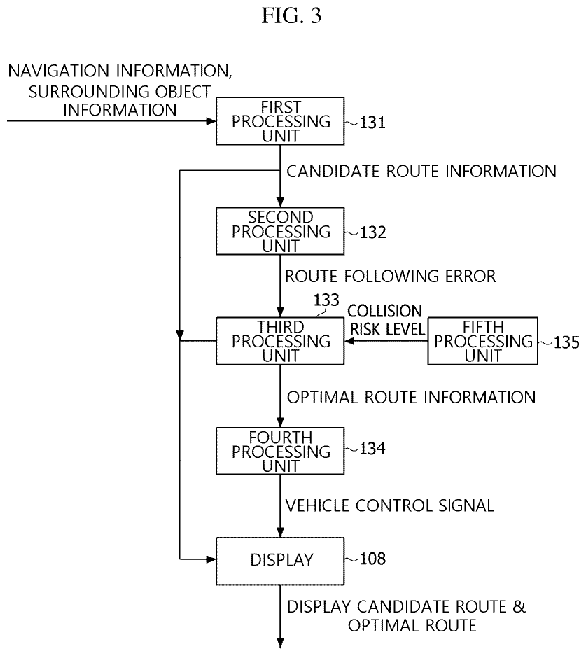

FIG. 3 is a diagram for describing the operation of the processor according to the embodiment. Referring to FIG. 3 together, the first processing unit 131 may generate a plurality of candidate routes to reach (e.g., merge with) a target route from a location of the host vehicle using navigation information of the navigation unit and surrounding object information detected by the sensor.

The navigation information may include at least one of map information, set destination information, route information according to a set destination, information on various objects on the route, lane information, and current vehicle location information. In the embodiment, the map information may refer to high definition (HD) map information.

The surrounding object information may refer to recognition information on an object outside the vehicle detected by the camera 104a, the lidar sensor 104b, and the radar sensor 104c of the first sensor 102. The surrounding object information may include image information, cloud point information, and the like.

The first processing unit 131 may generate the candidate routes to connect a location of the host vehicle and the target route along a center route of a lane.

The first processing unit 131 may generate the plurality of candidate routes connecting a current location and the target route along the center of the lane using HD map information and surrounding object information. This process may refer to technology that allows a vehicle to travel safely and efficiently while the vehicle maintains the center of the lane.

The camera may scan a road environment in real time and capture images. This data may include lanes, signs, obstacles, pedestrians, road boundaries, and the like. In addition, the LiDAR or radar sensor may be complementarily used to collect information such as a distance and depth from an object.

The first processing unit 131 may extract a location and shape of a lane from a road image using an image processing algorithm (e.g., a CNN or a deep learning model). The first processing unit 131 may recognize a type of lane line (e.g., solid line, dotted line, or the like), a curvature of the lane (whether the lane is a curve), and the like, and convert them into coordinates.

The first processing unit 131 may determine the centerline of the lane currently recognized by the vehicle. This centerline may be used as a reference route for vehicle driving.

The first processing unit 131 may determine the location of the host vehicle using current location information about the vehicle. The target route may be determined using route information generated to reach the destination. That is, the target route may refer to any section on a vehicle driving route to reach the destination.

The first processing unit 131 may generate multiple routes to reach (e.g., merge with) the target route from the location of the host vehicle, and the routes may be generated as several candidate routes (path candidates) based on the center of the lane.

For example, the first processing unit 131 may generate the candidate routes using a mathematical model such as a spline curve, a Bezier curve, or the like. The first processing unit 131 may generate the candidate routes by considering dynamic limitations of the vehicle (e.g., turning radius, acceleration, and the like).

The reason for generating the plurality of candidate routes is that when there are multiple lanes, a choice is needed, and when there is an obstacle in front, an avoidance route is needed. Another reason is that the driving route needs to generate routes with different curvatures to match a road condition (e.g., a curve).

Alternatively, the first processing unit 131 may generate the candidate routes using a Frenet coordinate system.

The Frenet coordinate system is a coordinate system defined along curves of roads and routes, and may express the location of the vehicle based on the centerline of the road. The Frenet coordinate system may be expressed by an s-axis and a d-axis. The s-axis refers to a cumulative length (arc length) along a reference route of the road and corresponds to a driving direction of the vehicle. The d-axis refers to a vertical distance from the reference route of the road and represents a lateral deviation.

The first processing unit 131 may independently process the s-axis and d-axis when generating a candidate route using the Frenet coordinate system. That is, s(t) represents a longitudinal route related to a driving speed and indicates how far the vehicle moves to the target route, and d(t) represents a lateral route of the road and indicates how far the vehicle deviates from the center of the lane.

The first processing unit 131 may set the center route of the road (e.g., the centerline of the lane) as the reference route. This route may be provided in map information (HD Map).

The first processing unit 131 may process the reference route as a smooth curve such as a spline or Bezier curve by considering a road curvature.

The first processing unit 131 may generate an acceleration profile including the speed and acceleration plan of the vehicle. This profile is represented by s(t) as shown in the following Equation 1, and represents a location on the route for time t.

$$s ( t ) = {s}_{0} + {v}_{0} \cdot t + \frac{1}{2} a \cdot {t}^{2} \qquad [ Equation 1 ]$$

In Equation 1, so is the initial location, v₀ is the initial speed, and a is the acceleration. The first processing unit 131 may generate multiple longitudinal candidate routes by considering various acceleration scenarios (stationary, gradual acceleration, and the like).

The first processing unit 131 may determine a route that the vehicle takes when moving from the current location to the center of the lane or to another lane as the lateral route. This may be used when changing lanes or avoiding an obstacle. The first processing unit 131 may generate various lateral candidate routes to determine how much lateral deviation the vehicle allows.

The first processing unit 131 may generate the location d(t) of the vehicle as a polynomial. The first processing unit 131 may calculate d(t) using a third or fifth degree polynomial as in the following Equation 2 or Equation 3.

$$d ( t ) = {a}_{0} + {a}_{1} t + {a}_{2} t + {a}_{3} t \qquad [ Equation 2 ]$$

$$d ( t ) = {a}_{0} + {a}_{1} t + {a}_{2} {t}^{2} + {a}_{3} {t}^{2} {a}_{4} {t}^{4} + {a}_{5} {t}^{5} \qquad [ Equation 3 ]$$

In Equations 2 and 3, a₀, a₁, . . . , a₅ are coefficients determined based on boundary conditions (an initial location, speed, acceleration), and the first processing unit 131 may set boundary conditions such as the initial location, speed, and acceleration when generating the route.

The initial location may refer to the current location (s₀, d₀) of the vehicle, the initial speed may refer to the current speed (v₀) of the vehicle, and the initial acceleration may refer to the current acceleration (a₀) of the vehicle.

The location or speed of the target route may also be set as boundary conditions.

For example, when the vehicle moves from its current location to the center of the lane, the initial location may be set as d₀=0, and the target location may be set as d_{goal}=3.5 m (half of the lane width).

The first processing unit 131 may generate multiple candidate routes by combining the longitudinal and lateral routes. Each route may be expressed as a function of location over time, as (s(t), d(t)).

The second processing unit 132 may determine a route tracking error (also referred to as a path tracking error, a route following error, a route deviation, etc.) on a route on which the host vehicle is traveling. The route tracking error may refer to the amount of deviation from the intended route. The second processing unit 132 may determine the route tracking error using the steering angle and acceleration values for maintaining the center route of the lane.

In the embodiment, when the vehicle is traveling along a candidate route, control is performed to follow the route using the steering angle and the acceleration. In this process, an error may occur between an actual location of the vehicle and the centerline (reference route) location of the route, and the second processing unit 132 may perform route tracking control (also referred to as route tracking) to accurately calculate and correct the error.

The error that occurs in the route tracking control may include a lateral error e_{y}, which represents how much the current location of the vehicle deviates to the left or right from the candidate route (centerline) and a heading error θₑ, which represents an angular difference between the vehicle's driving direction (heading) and a driving direction of the route.

The second processing unit 132 may determine the route tracking error in a vehicle coordinate system. The current location of the vehicle is represented as (xᵥ, yᵥ), and may refer to a point corresponding to the center of front wheels of the vehicle.

When a closest point (reference point) on the route is (xᵣ, yᵣ) and the reference heading of the route at the corresponding point is defined as θᵣ, the lateral error e_{y} may be calculated as a vertical distance between the current location of the vehicle and the closest point on the route.

For example, the second processing unit 132 may calculate the lateral error according to the following Equation 4.

$${e}_{y} = sin ( {θ}_{r} ) \cdot ( {x}_{v} - {x}_{r} ) - cos ( {θ}_{r} ) \cdot ( {y}_{v} - {y}_{r} ) \qquad [ Equation 4 ]$$

Equation 4 calculates an orthogonal distance between the location of the vehicle and the reference route, and when the vehicle is on the left side of the route, the error may be expressed as a positive number, and when the vehicle is on the right side, the error may be expressed as a negative number.

The heading error θₑ is a difference between the current driving direction (heading) θᵥ of the vehicle and the direction (heading) θᵣ of the route, and the second processing unit 132 may calculate the heading error according to the following Equation 5.

$${θ}_{e} = {θ}_{v} - {θ}_{r} \qquad [ Equation 5 ]$$

The second processing unit 132 may calculate the heading error through the difference between two heading values, and may normalize and express the calculated value within a range of −π to π. For example, when 0e is 200°, the second processing unit 132 may normalize θₑ and convert it to θₑ=−160°.

The third processing unit 133 may determine an optimal route to minimize the route tracking error using the candidate route when the route tracking error exceeds a preset threshold error value. As used herein, the term “optimal” route may refer to a best candidate route selected, among two or more candidate routes, according to a set of predetermined criteria. The optimal route may be also referred to as a selected route.

For example, the third processing unit 133 may determine the optimal route when a cumulative value of the number of times the route tracking error exceeds the threshold error value exceeds a preset threshold number of times. When the route tracking error value is accumulated and calculated as a high value, the third processing unit 133 may not select and follow a candidate route and may adjust a time point for following (e.g., tracking) the target route on the candidate route to determine the optimal route. In this way, minimizing the route tracking error may be established as a top priority strategy.

Alternatively, the third processing unit 133 may determine one of the candidate routes as the optimal route when the cumulative value of the number of times the route tracking error exceeds the threshold error value does not exceed the threshold number of times. That is, when the cumulative number of times the route tracking error is calculated as a high value is less than or equal to the threshold number of times, the optimal route may be determined by following (e.g., tracking) one of the existing candidate routes. In this way, it is possible to establish a top priority strategy that follows the existing candidate route.

The third processing unit 133 may determine one of the candidate routes as the optimal route when a collision risk level is equal to or higher than a preset threshold. That is, when the collision risk level is high, the optimal route may be determined by following (e.g., tracking) one of the existing candidate routes regardless of the cumulative number of times of the route tracking error. In this way, avoiding dangerous situations may be established as a top priority control strategy.

The third processing unit 133 may determine the optimal route using a cost function including a longitudinal/lateral jerk cost (e.g., a longitudinal jerk cost and lateral jerk cost), a target speed cost, and a target route offset cost.

When the cumulative value of the number of times the route tracking error exceeds the threshold error value exceeds the preset threshold number of times, the third processing unit 133 may determine the optimal route by adjusting a weight of the target route offset cost.

The third processing unit 133 may reflect the target route offset cost with the adjusted weight in the cost function and determine the optimal route so that the cost function is minimized.

The third processing unit 133 may evaluate the plurality of candidate routes that have already been generated and select the safest and most efficient route. The third processing unit 133 may determine a score of each route using the cost function that considers safety (e.g., the possibility of collision with obstacles), driving convenience (e.g., preference for routes with not too sharp curves), driving time (e.g., whether the target route may be reached in the shortest time), and fuel efficiency (e.g., a route without unnecessary rapid acceleration or deceleration), and the like, and select a candidate route with the lowest score (that is, most optimized) as the optimal route.

In the embodiment, the third processing unit 133 may determine the optimal route using the cost function including longitudinal and lateral jerks, the target speed cost, and the route offset cost.

The jerk refers to a rate of change in acceleration of the vehicle, and has to be minimized to prevent riding comfort from deteriorating when the vehicle changes the speed or direction abruptly.

When the jerk cost is minimized, it is possible to smooth the motion of the vehicle, provide more comfortable ride to occupants, and improve the durability of vehicle components.

The target speed cost is an indicator for the vehicle to travel while maintaining the target speed (e.g., 60 km/h) when traveling along the driving route. A speed that is too slow or too fast may be inefficient or dangerous, and by minimizing the cost, it is possible to guide the vehicle to approach its target speed.

The target route offset cost is an indicator to ensure that the vehicle does not deviate from the centerline of the target route (e.g., the center of the lane) on which the vehicle has to travel. The target route offset cost measures how much the vehicle deviates from the route centerline, and may be expressed as the integral of the route tracking error. When minimizing the target route offset cost, it is possible to guide the vehicle to travel exactly along the centerline.

The third processing unit 133 may define the cost function that combines each of the costs to select the optimal route among multiple candidate routes. The third processing unit 133 may adjust which factors are more important to consider when selecting a route by assigning a weight to each cost.

For example, the third processing unit 133 may define the cost function as in the following Equation 6.

$${J}_{total} = {w}_{1} \cdot {J}_{lon} + {w}_{2} \cdot {J}_{lat} + {w}_{3} \cdot {C}_{velocity} + {w}_{4} \cdot {C}_{offset} \qquad [ Equation 6 ]$$

In Equation 6, Jₗₒₙ is the longitudinal jerk, Jₗₐₜ is the lateral jerk, C_{velocity} is the target speed cost, and C_{offset} is the target route offset cost, and w₁, w₂, w₃, and w₄ are weights for each cost item.

In the embodiment, all weight values may be set to upper/lower threshold values using empirical numerical values determined by combining experimental results of the route generation process and the route tracking process.

For example, the third processing unit may set the values of w₁ and w₂ to be large when driving comfort is considered more important, and on the other hand, may set the value of w₄ to be large when accurate route tracking is more important.

The third processing unit 133 may determine cost function values of all candidate routes and select a route with the lowest cost as the optimal route. For example, when the vehicle needs to detour around an obstacle while traveling, some candidate routes may have high lateral jerk costs because the candidate routes have to turn sharply to avoid the obstacle, and other candidate routes may be smooth but may make it difficult to maintain the target speed, thereby increasing the speed cost.

In the embodiment, the third processing unit 133 may adjust the value of the weight w₄ of the target route offset cost when the cumulative value of the number of times the route tracking error exceeds the threshold error value exceeds the preset threshold number of times. When the route tracking error accumulates and becomes large, it may mean that the vehicle is traveling on a sharp curve section or the like where it is difficult to accurately follow the route. Accordingly, the third processing unit 133 may adjust the cost function to follow the route more easily and smoothly than accurate route tracking by adjusting the value of the weight of the target route offset cost to be lower. When adjusting the value of the weight of the target route offset cost to be lower as described above, a lower limit threshold of the weight may be predefined. This is because, when the lower limit threshold of the weight is not set, only routes that do not reduce the route tracking error may be repeatedly selected, and as a result, the overall route tracking control may not converge but rather diverge. Therefore, the third processing unit 133 may set the lower limit threshold of the weight of the target route offset cost using empirical numerical values obtained through the repeated experimental process of route generation and route tracking. By adjusting the target route offset cost to be lower in this way, excessive lateral control or longitudinal control to accurately follow the target route may not be performed.

The third processing unit 133 determines the optimal route by considering the balance between the costs, but when a large route tracking error cumulatively occurs, the constraints for following (e.g., tracking) the target route may be temporarily relaxed so that the optimized route may be determined between the candidate route generation process and the following control process.

The processor may perform real-time optimal route recalculation by generating new candidate routes and recalculating costs when road conditions (e.g., appearance of obstacles, change in road curvature) change during driving.

The fourth processing unit 134 may determine a vehicle control signal for following (e.g., tracking) the optimal route.

The fourth processing unit 134 may comprehensively consider and reflect the lateral error and heading error in the vehicle control signal.

The fourth processing unit 134 may reflect the lateral error and heading error in the vehicle control signal through the cost function according to the following Equation 7.

$$J ( {e}_{y} , {θ}_{e} ) = {k}_{1} \cdot {e}_{y}^{2} + {k}_{2} \cdot {θ}_{e}^{2} \qquad [ Equation 7 ]$$

In Equation 7, k₁ and k₂ may represent weights that adjust the importance of the lateral error e_{y} and the heading error θₑ, respectively. The fourth processing unit 134 may control the steering angle and acceleration of the vehicle in a direction that minimizes the cost function.

The fourth processing unit 134 may use algorithms such as proportional-integral-derivative (PID) control or model predictive control (MPC) to reduce the route tracking error.

In PID control, the lateral error may be used to control the steering angle of the vehicle.

The fourth processing unit 134 may calculate a steering angle input δ according to the following Equation 8.

$$δ = {K}_{p} \cdot {e}_{y} + {K}_{d} \cdot \frac{{de}_{y}}{dt} + {K}_{i} \cdot \int {e}_{y} dt \qquad [ Equation 8 ]$$

In Equation 8, Kₚ, K_{d}, and Kᵢ may represent proportional, differential, and integral gains, respectively. As e_{y} increases, the steering angle may be adjusted more greatly.

MPC may use a vehicle dynamics model and the cost function to pre-calculate a predictable route and error, and determine an optimal steering angle and acceleration that satisfy the cost function. The fourth processing unit 134 may adjust the steering angle and acceleration so that the vehicle minimizes error for a specific time in the future.

The fourth processing unit 134 may determine the location and route error of the vehicle in real time for each control cycle during driving. While driving along the route, errors may increase rapidly during obstacle avoidance or curved sections, and the fourth processing unit 134 may generate a new route or modify control inputs in real time.

The fifth processing unit 135 may determine a collision risk level using the vehicle driving information about the host vehicle and the surrounding object information.

The fifth processing unit 135 may use information on the driving speed, driving distance, and driving time of the host vehicle detected by the second sensor and location information and speed information about a surrounding object detected by the first sensor to determine information on real-time changing coordinates of the surrounding object and information on a relative distance and relative speed between the host vehicle and surrounding objects.

The fifth processing unit 135 may determine an expected collision time between the host vehicle and the surrounding object based on the relative distance and relative speed between the host vehicle and the surrounding object, and may determine the collision risk level based on the determined expected collision time. The fifth processing unit 135 may determine that the collision risk level is equal to or greater than a preset threshold when the expected collision time is less than a preset threshold time.

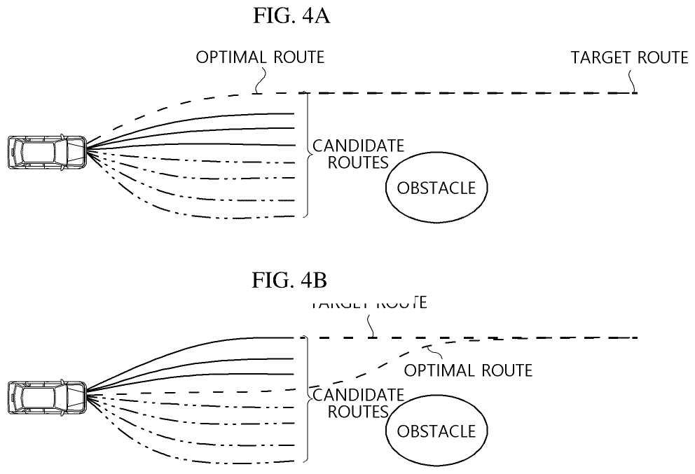

FIGS. 4A and 4B are conceptual diagrams for describing an optimal route tracking process of a vehicle according to an embodiment.

Referring to FIG. 4A, in at least some implementations of route tracking control, even in a situation where a large amount of route tracking errors continuously occur, a strategy to select one of the already generated candidate routes and to follow the target route according to the candidate route without considering the situation may be used. In such cases, the route tracking error may become more severe and driving instability may increase over time.

Referring to FIG. 4B, the vehicle control device according to the present disclosure may adjust the weight of the target route offset cost that reflects a degree of tracking the target route to be lower in the cost function if the route tracking error having a large value continues to occur. Therefore, rather than only following the target route along the candidate routes, an optimal (e.g., adjusted) route may be generated that converges more gradually to the target route in a direction that reduces the route tracking error.

In this case, the processor may visually display the candidate routes and the optimal route through the display.

The processor 130 may determine the driving strategy based on the optimal route and controls the vehicle's behavior accordingly. The processor 130 may control the behavior of the host vehicle based on the lateral control and longitudinal control of the vehicle.

The processor may determine the vehicle control signal such as lane keeping, deceleration, lane changing, acceleration, or the like, according to the driving strategy.

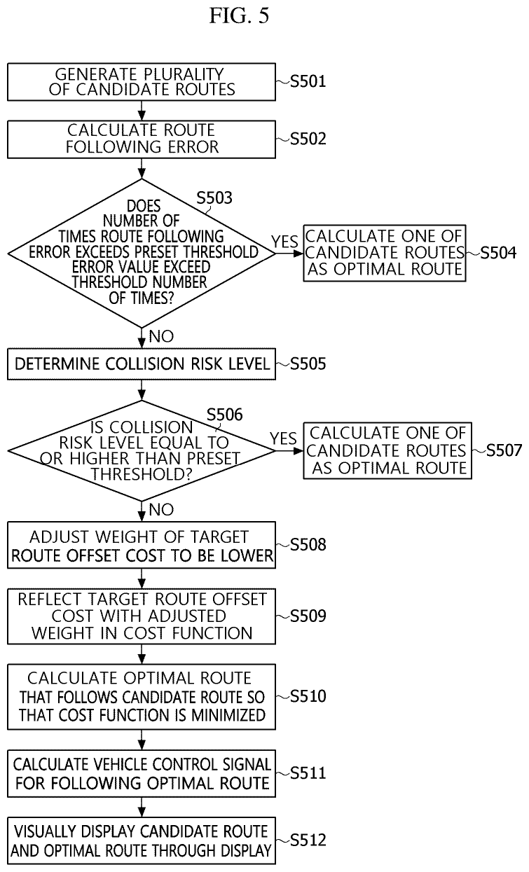

FIG. 5 is a flowchart of a method of controlling a vehicle according to an embodiment.

Referring to FIG. 5, the processor generates a plurality of candidate routes to reach (e.g., merge with) a target route from a location of the host vehicle using navigation information of the navigation unit and surrounding object information detected by the sensor (S501).

The processor determines a route tracking error on the route on which the host vehicle is traveling (S502).

The processor determines whether the number of times the route tracking error exceeds a preset threshold error value exceeds a threshold number of times (S503).

When a cumulative value of the number of times the route tracking error exceeds the threshold error value does not exceed the threshold number of times, the processor determines one of the candidate routes as the optimal route. In this case, the processor determines a candidate route that minimizes a cost function including a longitudinal/lateral jerk cost, a target speed cost, and a target route offset cost as the optimal route (S504).

When the cumulative value of the number of times the route tracking error exceeds the threshold error value exceeds the threshold number of times, the processor determines a collision risk level using vehicle driving information about the host vehicle and surrounding object information (S505).

When the collision risk level is equal to or greater than a preset threshold, the processor determines one of the candidate routes as the optimal route. In this case, the processor determines a candidate route that minimizes the cost function including the longitudinal/lateral jerk cost, the target speed cost, and the target route offset cost among candidate routes that may avoid collision as the optimal route (S506 and S507).

When the collision risk level is less than a preset threshold, the processor adjusts a weight of the target route offset cost to be lower (S508).

The processor reflects the target route offset cost with the adjusted weight in the cost function, and determines an optimal route that follows the candidate route so that the cost function is minimized (S509 and S510).

The processor generates a vehicle control signal for following (e.g., tracking) the optimal route (S511).

In addition, the processor visually displays the candidate routes and the optimal route through the display (S512).

According to an aspect of the present disclosure, there is provided a vehicle control device including one or more processors and a memory storing one or more programs executed by the one or more processors, in which the processor is configured to generate a plurality of candidate routes to reach a target route from a location of a host vehicle using navigation information of a navigation unit and surrounding object information detected by a sensor unit, determine a route following error on a route on which the host vehicle is traveling, determine an optimal route to minimize the route following error using the candidate routes, and determine a vehicle control signal to follow the optimal route.

The processor may determine the optimal route when a cumulative value of the number of times the route following error exceeds a preset threshold error value exceeds a preset threshold number of times.

The processor may generate the candidate routes to connect the location of the host vehicle and the target route along a center route of the lane.

The processor may determine the route following error using steering angle and acceleration values for maintaining the center route of the lane.

The processor may determine the optimal route using a cost function including a longitudinal/lateral jerk cost, a target speed cost, and a target route offset cost.

The processor may determine the optimal route by adjusting a weight of the target route offset cost.

The processor may reflect the target route offset cost with the adjusted weight in the cost function and determine the optimal route so that the cost function is minimized.

The processor may determine one of the candidate routes as the optimal route when the cumulative value of the number of times the route following error exceeds the threshold error value does not exceed the threshold number of times.

The processor may determine a collision risk level using vehicle driving information about the host vehicle and the surrounding object information.

The processor may determine one of the candidate routes as the optimal route when the collision risk level is equal to or higher than a preset threshold.

According to another aspect of the present disclosure, there is provided a method of controlling a vehicle performed by a computing device including one or more processors and a memory storing one or more programs executed by the one or more processors, including generating, by the processor, a plurality of candidate routes to reach a target route from a location of a host vehicle using navigation information of a navigation unit and surrounding object information detected by a sensor unit, calculating, by the processor, a route following error on a route on which the host vehicle is traveling, calculating, by the processor, an optimal route to minimize the route following error using the candidate routes, and calculating, by the processor, a vehicle control signal to follow the optimal route.

In the calculating of the optimal route, the optimal route may be determined when a cumulative value of the number of times the route following error exceeds a preset threshold error value exceeds a preset threshold number of times.

In the generating of the candidate routes, the candidate routes may be generated to connect the location of the host vehicle and the target route along a center route of the lane.

In the calculating of the route following error, the route following error may be determined using steering angle and acceleration values for maintaining the center route of the lane.

In the calculating of the optimal route, the optimal route may be determined using a cost function including a longitudinal/lateral jerk cost, a target speed cost, and a target route offset cost.

In the calculating of the optimal route, the optimal route may be determined by adjusting a weight of the target route offset cost.

In the calculating of the optimal route, the target route offset cost with the adjusted weight may be reflected in the cost function, and the optimal route may be determined so that the cost function is minimized.

In the calculating of the optimal route, one of the candidate routes may be determined as the optimal route when the cumulative value of the number of times the route following error exceeds the threshold error value does not exceed the threshold number of times.

The method may further include, prior to the calculating of the optimal route, determining a collision risk level using vehicle driving information about the host vehicle and the surrounding object information.

In the calculating of the optimal route, one of the candidate routes may be determined as the optimal route when the collision risk level is equal to or higher than a preset threshold.

The term “unit” used in the present embodiment refers to software components or hardware components such as a field-programmable gate array (FPGA) or an application specific integrated circuit (ASIC), and “unit” performs certain functions. However, the “unit” is not limited to software or hardware. The “unit” may be configured to reside in an addressable storage medium, or may be configured to reproduce one or more processors. Therefore, for example, “unit” includes components such as software components, object-oriented software components, class components, and task components, and includes processes, functions, attributes, procedures, sub-routines, segments of program code, drivers, firmware, micro code, circuits, data, a database, data structures, tables, arrays, and variables. Functions provided in the components and the “unit” may be combined into smaller numbers of components and “units,” or may be further divided into additional components and “units.” Furthermore, the components and “units” may be implemented to reproduce one or more CPUs in a device or a security multimedia card.

By considering following performance in a route generation stage according to an embodiment and reflecting a following error in the route generation in real time, it is possible to minimize driving instability due to accumulated errors.

In addition, it is possible to improve the controllability of a vehicle.

In addition, it is possible to significantly improve the driving stability, riding comfort, and efficiency of an autonomous vehicle.

Although the preferred embodiments of the present disclosure have been described above, it is understood that those skilled in the art may make various changes and modifications to the present disclosure without departing from the spirit and scope of the present disclosure set forth in the claims below.

What is claimed is:

1. An apparatus of a vehicle, the apparatus comprising:
one or more processors; and
a memory storing at least one instruction that is configured, when executed by the one or more processors communicating with the memory, to cause the apparatus to:
generate, via a navigation system of the vehicle and based on surrounding object information obtained from a sensor of the vehicle, a plurality of candidate routes to merge with a target route from a location of the vehicle;
determine an amount of deviation, from the target route, of a route on which the vehicle is traveling;
determine an optimal route, among the plurality of candidate routes, that minimizes the amount of deviation from the target route;
generate a vehicle control signal to follow the optimal route; and
control, based on the vehicle control signal, a driving operation of the vehicle.

2. The apparatus of claim 1, wherein the at least one instruction is configured, when executed by the one or more processors communicating with the memory, to cause the apparatus to determine the optimal route by:
determining the optimal route based on a number of times, that the amount of deviation of the route exceeds a threshold deviation amount, being greater than a threshold quantity value.

3. The apparatus of claim 1, wherein the at least one instruction is configured, when executed by the one or more processors communicating with the memory, to cause the apparatus to generate the plurality of candidate routes by:
generating the plurality of candidate routes to connect the location of the vehicle to the target route along a center route of a lane on which the vehicle is traveling.

4. The apparatus of claim 3, wherein the at least one instruction is configured, when executed by the one or more processors communicating with the memory, to cause the apparatus to determine the amount of deviation of the route by:
determining the amount of deviation of the route based on steering angle and acceleration values of the vehicle for maintaining the center route of the lane.

5. The apparatus of claim 2, wherein the at least one instruction is configured, when executed by the one or more processors communicating with the memory, to cause the apparatus to determine the optimal route by:
determining the optimal route based on a cost function, wherein the cost function comprises a longitudinal and lateral jerk cost, a target speed cost, and a target route offset cost.

6. The apparatus of claim 5, wherein the at least one instruction is configured, when executed by the one or more processors communicating with the memory, to cause the apparatus to determine the optimal route by adjusting a weight of the target route offset cost.

7. The apparatus of claim 6, wherein the at least one instruction is configured, when executed by the one or more processors communicating with the memory, to cause the apparatus to determine the optimal route by:
applying the target route offset cost, with the adjusted weight, in the cost function and determining the optimal route so that the cost function is minimized.

8. The apparatus of claim 1, wherein the at least one instruction is configured, when executed by the one or more processors communicating with the memory, to cause the apparatus to determine the optimal route by:
determining, based on a number of times, that the amount of deviation of the route exceeds a threshold deviation amount, being less than a threshold quantity value, one of the plurality of candidate routes as the optimal route.

9. The apparatus of claim 1, wherein the at least one instruction is configured, when executed by the one or more processors communicating with the memory, to cause the apparatus to determine the optimal route by:
determining, based on vehicle driving information about the vehicle and the surrounding object information, a collision risk level; and
determining, based on the collision risk level being greater than or equal to a threshold value, one of the plurality of candidate routes as the optimal route.

10. The apparatus of claim 1, wherein the at least one instruction is configured, when executed by the one or more processors communicating with the memory, to further cause the apparatus to display, via a display device of the vehicle, the plurality of candidate routes and the optimal route.

11. A method performed by an apparatus of a vehicle, the method comprising:
generating, via a navigation system of the vehicle and based on surrounding object information obtained from a sensor of the vehicle, a plurality of candidate routes to merge with a target route from a location of the vehicle;
determining an amount of deviation, from the target route, of a route on which the vehicle is traveling;
determining an optimal route, among the plurality of candidate routes, that minimizes the amount of deviation from the target route;
generating a vehicle control signal to follow the optimal route; and
controlling, based on the vehicle control signal, a driving operation of the vehicle.

12. The method of claim 11, wherein the determining of the optimal route comprises:
determining the optimal route based on a number of times, that the amount of deviation of the route exceeds a threshold deviation amount, being greater than a threshold quantity value.

13. The method of claim 11, wherein the generating of the plurality of candidate routes comprises:
generating the plurality of candidate routes to connect the location of the vehicle to the target route along a center route of a lane on which the vehicle is traveling.

14. The method of claim 13, wherein the determining of the amount of deviation of the route comprises:
determining the amount of deviation of the route based on steering angle and acceleration values of the vehicle for maintaining the center route of the lane.

15. The method of claim 12, wherein the determining of the optimal route comprises:
determining the optimal route based on a cost function, wherein the cost function comprises a longitudinal and lateral jerk cost, a target speed cost, and a target route offset cost.

16. The method of claim 15, wherein the determining of the optimal route comprises adjusting a weight of the target route offset cost.

17. The method of claim 16, wherein the determining of the optimal route comprises:
applying the target route offset cost, with the adjusted weight, in the cost function and determining the optimal route so that the cost function is minimized.

18. The method of claim 11, wherein the determining of the optimal route comprises:
determining, based on a number of times, that the amount of deviation of the route exceeds a threshold deviation amount, being less than a threshold quantity value, one of the plurality of candidate routes as the optimal route.

19. The method of claim 11, further comprising, prior to the determining of the optimal route, determining, based on vehicle driving information about the vehicle and the surrounding object information, a collision risk level.

20. The method of claim 19, wherein the determining of the optimal route comprises:
determining, based on the collision risk level being greater than or equal to a threshold value, one of the plurality of candidate routes as the optimal route.
